(19) United States
(12) Patent Application Publication
(10) Pub. No.: US 2019/0303206 A1
(43) Pub. Date: Oct. 3, 2019

(54) INFORMATION PROCESSING APPARATUS, INFORMATION PROCESSING METHOD, AND RECORDING MEDIUM

(71) Applicant: Norihiko Shutoh, Tokyo (JP)

(72) Inventor: Norihiko Shutoh, Tokyo (JP)

(73) Assignee: Ricoh Company, Ltd., Tokyo (JP)

(21) Appl. No.: 16/243,395

(22) Filed: Jan. 9, 2019

(30) Foreign Application Priority Data
Mar. 30, 2018 (JP) 2018-070193

(51) Int. Cl. G06F 9/50; G06F 3/06; G06F 9/48

(52) U.S. Cl. CPC G06F 9/5038; G06F 3/0604; G06F 3/0631; G06F 9/4881; G06F 3/0673; G06F 9/5016; G06F 3/0659

(57) ABSTRACT

An information processing apparatus includes an internal memory to store information on a process-end prohibition item being an application program or service whose process end is prohibited in an operation system of the apparatus or a system employing the information processing apparatus. The circuitry detects a remaining capacity of a memory in response to a use request for the memory; detects an occupying application program and an occupying service occupying the memory; refers to the information on the process-end prohibition item in response to a result that the remaining capacity of the memory becomes equal to a threshold or smaller by use of the memory in accordance with the use request; selects, from the occupying application program and the occupying service, an item that is not the process-end prohibition item; and ends a process of the selected unprohibited item to reserve a capacity requested by the use request.

### CROSS-REFERENCE TO RELATED APPLICATION

This patent application is based on and claims priority pursuant to 35 U.S.C. § 119(a) to Japanese Patent Application No. 2018-070193, filed on Mar. 30, 2018, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Description of the Related Art

A general operating system (OS) that performs main control of devices has a memory management function for managing the remaining amount of a memory in order to effectively use the memory. The memory management function of the OS is configured to end processes of applications and services unnecessary to the OS, thereby securing the memory capacity, when the remaining amount of the memory becomes small due to operation of an application program (application), a service, etc.

Further, when the memory capacity necessary for executing a new application does not remain in a volatile memory, some electronic devices are configured to refer to termination prohibited application information in the nonvolatile memory and end an application that is ongoing or suspended except a termination prohibited application. With such a configuration, a new application can be executed without requiring user intervention while a plurality of applications is ongoing.

### SUMMARY

According to an embodiment of this disclosure, an information processing apparatus includes an internal memory configured to store information on at least one process-end prohibition item being one of an application program and a service whose process end is prohibited in one of an operation system of the information processing apparatus and a system employing the information processing apparatus. The information processing apparatus further includes circuitry configured to detect a remaining capacity of a memory in response to a use request for the memory; detect an occupying application program and an occupying service occupying the memory; refer to the information on the at least one process-end prohibition item stored in the internal memory, in response to a detection result that the remaining capacity of the memory becomes equal to or smaller than a threshold by use of the memory in accordance with the use request; select, from the occupying application program and the occupying service occupying the memory, an unprohibited item that is not contained in the information on the at least one process-end prohibition item; and end a process of the selected unprohibited item to reserve, on the memory, a capacity requested by the use request.

Another embodiment provides an information processing method. The method includes detecting a remaining capacity of a memory in response to a use request for the memory, detecting an occupying application program and an occupying service occupying the memory; and referring to information on at least one process-end prohibition item in response to a detection result that the remaining capacity of the memory becomes equal to or smaller than a threshold by use of the memory in accordance with the use request. The at least one process-end prohibition item is one of an application program and a service whose process end is prohibited in at least one of an operation system of an information processing apparatus and a system employing the information processing apparatus. The method further includes selecting, from the occupying application program and the occupying service occupying the memory, an unprohibited item that is not in the information on the at least one process-end prohibition item; and ending a process of the selected unprohibited item to reserve, on the memory, a capacity requested by the use request.

Another embodiment provides a non-transitory recording medium storing a plurality of program codes which, when executed by one or more processors, cause the processors to perform the method described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a hardware configuration of a multifunction peripheral (MFP) according to an embodiment of the present disclosure;

FIG. 2 is a functional block diagram of a control terminal according to an embodiment;

FIG. 3 is a diagram for explaining an operation for registering a whitelist of the MFP illustrated in FIG. 1;

FIG. 4 is a flowchart illustrating a memory management function of the MFP, according to an embodiment;

FIG. 5 is a flowchart illustrating a flow of operation for setting an authentication application in the whitelist in the MFP, according to an embodiment;

FIG. 6 is a flowchart illustrating an operation at system start-up including activation of an OS in the MFP, according to an embodiment; and

FIG. 7 is a flowchart illustrating a flow of operation for creating a priority list in the MFP, according to an embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, descriptions are given below of a multifunction peripheral (MFP) to which the information processing apparatus, the information processing method, and the information processing program according to embodiments of the present disclosure are applied. More specifically, a control terminal (an operation device) connected to the MFP is an example of the information processing apparatus, and the MFP is an example of a system employing the information processing apparatus. However, the information processing apparatus is not particularly limited as long as the information processing apparatus is an apparatus on which the application can be installed. For example, the information processing apparatus may be a main unit of a MFP, a personal computer, a smart device, an electronic whiteboard, a projector, or the like. As used herein, the singular forms “a”, “an”, and “the” are intended to include the plural forms as well, unless the context clearly indicates otherwise.

Hardware Configuration of MFP

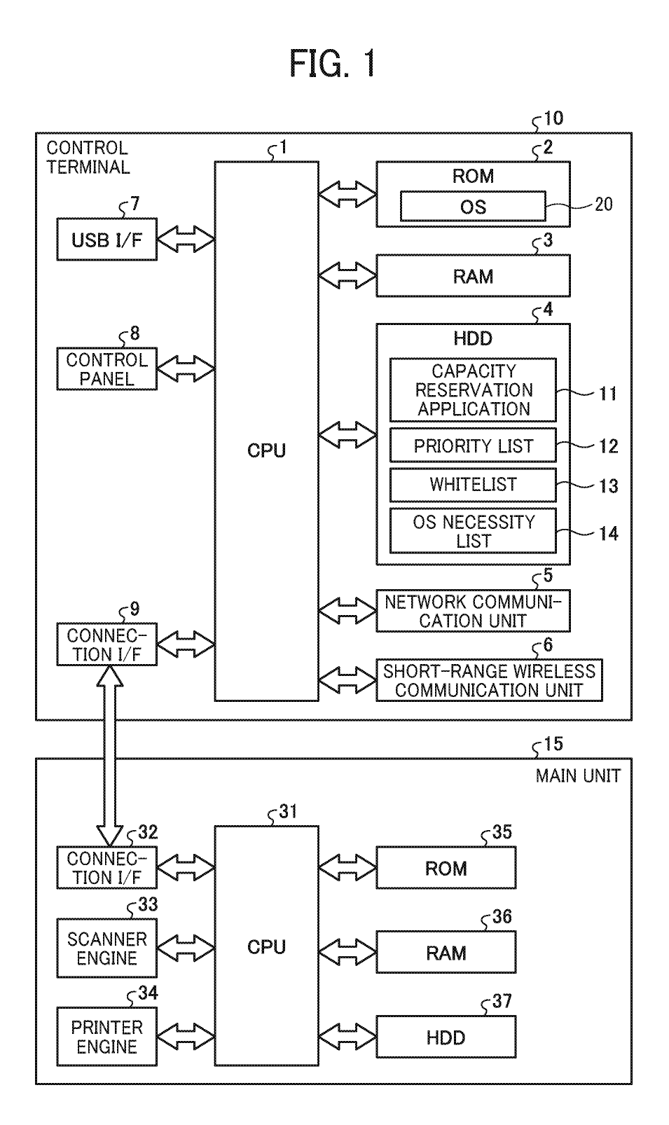

FIG. 1 is a block diagram illustrating a hardware configuration of a MFP according to the present embodiment. As illustrated in FIG. 1, the MFP according to the present embodiment includes a control terminal 10 and a main unit 15.

Hardware Configuration of Control Terminal

The control terminal 10 includes a central processing unit (CPU) 1, a read only memory (ROM) 2, a random access memory (RAM) 3, a hard disk drive (HDD) 4, a network communication unit 5, a short-range wireless communication unit 6, a universal serial bus (USB) interface (I/F) 7, a control panel 8 (an operation unit), and a connection I/F 9.

The ROM 2 stores an operating system (OS) 20, which is a program for controlling the entire control terminal 10. The HDD 4 stores a capacity reservation application 11 that ends processes of unnecessary application programs (applications) or services, to reserve a storage area, when the remaining memory amount of the RAM 3 or the like decreases. Instead of the HDD 4, a flash memory may be used. The CPU 1 loads the capacity reservation application 11 into the RAM 3 and executes the capacity reservation application 11. Details will be described later. The RAM 3 is an example memory. “Service” is a program that provides information or functions.

The HDD 4 (i.e., an internal memory) also stores a priority list 12 indicating priorities given to the respective applications and services, a whitelist 13 listing applications and services whose processes are not to be terminated when being active, and an OS necessity list 14 that is a list of applications and services necessary for the OS 20. As will be described in detail later, the priority list 12 is not preliminarily stored in the HDD 4 but is created based on the whitelist 13 and the OS necessity list 14.

The control panel 8 is a so-called touch panel including a display provided with a touch sensor. The control panel 8 outputs, for example, an execution command of printing or scanning to the CPU 1 based on a user touch operation. The control panel 8 can be, for example, an organic electro luminescence (EL) display device provided with a touch panel function. Alternatively, or additionally, the control terminal 10 can include an operation unit such as hardware keys, a display portion such as an indicator lamp, or both.

The control terminal 10 can be attached to and removed from the main unit 15. The control terminal 10 communicates with the main unit 15 by wired communication when attached to the main unit 15. The control terminal 10 performs wireless communication with the main unit 15 when removed from the main unit 15. The OS 20 that controls the operation of the control terminal 10 is, for example, Android (registered trademark). The OS 20 that controls the operation of the main unit 15 is, for example, Linux (registered trademark), etc. Thus, the control terminal 10 and the main unit 15 are designed to operate with different OSs.

In the example described below, the OS 20 of the control terminal 10 operates based on the capacity reservation application 11 installed on the control terminal 10 to end the process of an unnecessary application or the like operating on the control terminal 10, thereby reserving the capacity of the RAM 3 of the control terminal 10. Alternatively, the OS 20 of the control terminal 10 can operate based on the capacity reservation application 11 installed on the control terminal 10 to end the process of an unnecessary application or the like operating in the main unit 15, thereby reserving the capacity of a RAM 36 of the main unit 15. Further, the control terminal 10 may be a mobile terminal such as a smart device or a tablet terminal.

Yet alternatively, the OS of the main unit 15 can operate based on a capacity reservation application installed in the main unit 15 to end the process of an unnecessary application or the like operating on the control terminal 10, thereby reserving the capacity of the RAM 3 of the control terminal 10. Further, the OS 20 of the control terminal 10 may have all or a part of the functions (to be described later) of the capacity reservation application 11. Further, the capacity reservation application 11 may be an application having another function different from the memory capacity reservation function. In either case, the operation for capacity reservation is similar to the operation in the example described below.

Hardware Configuration of Main Unit

As illustrated in FIG. 1, the main unit 15 includes a CPU 31, a connection I/F 32, a scanner engine 33, a printer engine 34, a ROM 35, the RAM 36, and an HDD 37. The control terminal 10 is capable of communicating with the main unit 15, for example, by wired communication. The communication type is not limited thereto but can be wireless communication.

Functional Configuration of Control Terminal

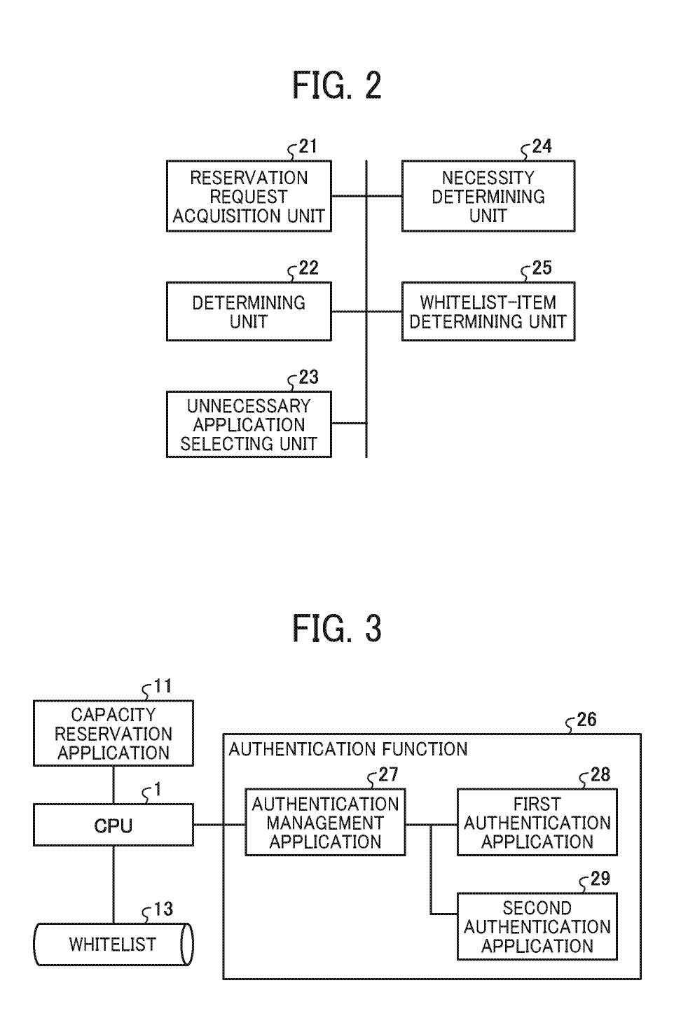

As illustrated in FIG. 2, in the control terminal 10 of the MFP according to the present embodiment, as the CPU 1 executes the capacity reservation application 11, the CPU 1 functions as a reservation request acquisition unit 21, a determining unit 22, an unnecessary application selecting unit 23, a necessity determining unit 24, and a whitelist-item determining unit 25. The determining unit 22 is an example of a remaining amount detection unit. For example, the determining unit 22 detects the remaining amount of the storage area of the RAM 3 and determines whether or not the remaining amount of the RAM 3 suffices the memory amount requested by the application or the like.

The reservation request acquisition unit 21 acquires a memory reservation request from a newly activated application or the like. The reservation request acquisition unit 21 may acquire a memory reservation request from an already-activated application or the like, for example, when the already-activated application executes a process. Based on the priority list 12 stored on the RAM 3 or the HDD 4, the unnecessary application selecting unit 23 selects an unnecessary application or service from the applications or services that are currently deployed in the RAM 3. The necessity determining unit 24 determines an application or service that is unnecessary for the OS 20, among the applications or services currently deployed in the RAM 3. The whitelist-item determining unit 25 detects an application or a service which is an object of process prohibition or restriction, among the applications or services determined to be unnecessary. The unnecessary application selecting unit 23 is an example of an occupying-application detecting unit and an example of a capacity reservation unit.

In this example, the reservation request acquisition unit 21, the determining unit 22, the unnecessary application selecting unit 23, the necessity determining unit 24, and the whitelist-item determining unit 25 are realized by software, but some or all of the functions of the control terminal 10 can be realized by hardware such as an integrated circuit (IC).

The capacity reservation application 11 can be provided as a file of either an installable or executable format and recorded on a recording medium readable by a computer, such as a compact disc read only memory (CD-ROM) and a flexible disk (FD). Alternatively, the capacity reservation application 11 can be provided in the form recorded on a computer-readable recording medium, such as a compact disc-recordable (CD-R), a digital versatile disk (DVD), a Blu-ray Disc (registered trademark), and a semiconductor memory. Yet alternatively, the capacity reservation application 11 can be installed via a network such as the Internet or preliminarily incorporated in the ROM or the like of the device.

Overview of Memory Reservation

In the MFP according to the present embodiment, the CPU 1 executes the capacity reservation application 11 to end processes of unnecessary applications and services, thereby reserving the capacity (memory management function), when the remaining capacity of the RAM 3 becomes equal to or smaller than a threshold, which can be set by a manufacture of the MFP, for example. The CPU determines the unnecessary applications and services among the applications and services that are not registered in the whitelist 13 and the OS necessity list 14. In the whitelist 13, the applications and services are preliminarily registered by the manufacturer of the MFP or registered by user setting.

For example, in the case of an authentication function 26 illustrated in FIG. 3, an authentication management application 27 manages first and second authentication applications 28 and 29, and one of the first and second authentication applications 28 and 29 is selected to be used by the user setting. Therefore, it is difficult for the manufacturer of the MFP to register the applications and services in advance in the whitelist 13. Therefore, the manufacturer of the MFP registers, in the memory such as the HDD 4, information (e.g., the names of the applications) for the authentication management application 27 to identify the authentication application selected by the user (specifying information) when the user selects the authentication application to be used. When the storage area of the RAM 3 decreases to or below the threshold, the OS 20 retrieves the specifying information (e.g., the application name) from the HDD 4 and registers the retrieved specifying information in the whitelist 13 as the application or service whose process is not to be terminated.

Note that the time of registering the applications and services in the whitelist 13 is not limited to the description above and can be executed any time. For example, at the selecting of the authentication application (the first authentication application 28 or the second authentication application 29) by the user, the selected authentication application can be registered in the whitelist 13.

Here, some applications or services are unnecessary for the OS 20 and accordingly not registered on the OS necessity list 14 but are required for the system of the MFP, that is, registered in the whitelist 13. Examples of such applications or services include “controller control application”, “authentication control application”, “software development kit (SDK)”, and “real-time processing service”.

“Controller control application” is an application that controls the main unit 15 of the MFP. When the communication between the control terminal 10 and the main unit 15 is disconnected, a mismatch of control state will occur between the CPU 1 of the control terminal 10 and the CPU 31 of the main unit 15, and an error occurs. Accordingly, the process end of “controller control application” is prohibited.

“Authentication control application” is an application that requires login performance at the time of user authentication. “SDK” is a service that needs immediately response as correspondence of an SDK published to a third vendor. “Real-time processing service” is a service that should operate in real time and adversely affects user operation if a notification such as error indication to the user is delayed.

Memory Management Function

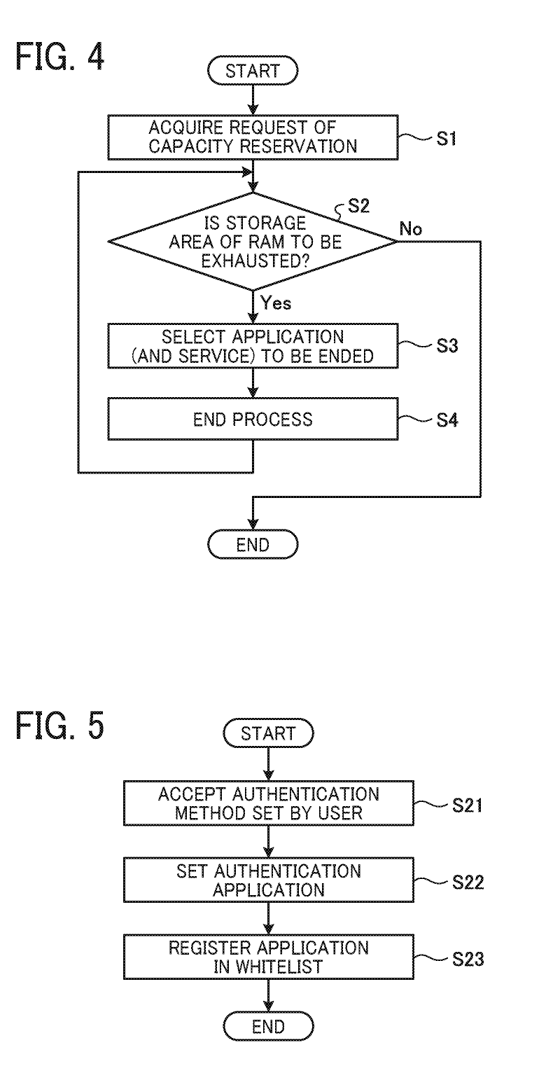

The CPU 1 executes the capacity reservation application 11 to realize the memory management function described with reference to the flowchart in FIG. 4. The priority of each application is set in advance (at system startup) before the execution of memory management, which will be described later.

In S1, the reservation request acquisition unit 21 acquires a request of capacity reservation of the RAM 3. As an example of capacity reservation of the RAM 3, when an application is newly activated, the application requests the CPU 1 to reserve the capacity of the RAM 3. As another example, when an already-activated application executes a process or function, the application requests to reserve the capacity of the RAM 3 to reserve additional capacity.

In S2, the determining unit 22 detects the remaining amount of the storage area of the RAM 3 and determines whether or not the storage area of the RAM 3 is to be exhausted. In response to a determination that the remaining capacity amount of the RAM 3 suffices the data amount requested by the application or the like (No in S2), the data of the application requesting the capacity can be loaded into the RAM 3. Thus, the CPU 1 ends the process of the flowchart in FIG. 4.

On the other hand, in response to a determination that the remaining amount of the RAM 3 is insufficient for the data amount requested by the application or the like, or the remaining amount of the RAM 3 becomes equal to or smaller than the threshold when the application data is loaded into the RAM 3 (Yes in S2), the determining unit 22 is not able to load the data of the requesting application into the RAM 3. Therefore, in S3, the unnecessary application selecting unit 23 selects an unnecessary application and a service from the currently active applications and services based on the priority of the application or service.

More specifically, the unnecessary application selecting unit 23 refers to the priority list 12 to be described later and selects an application and a service the process of which is to be ended (S3). The unnecessary application selecting unit 23 ends the process of the applications and services with the lowest priorities among the applications and services set in the priority list 12 (S4). An example of the priority list 12 is presented in Table 1 below.

TABLE 1

| | Priority (High-Low) | | | | | |
|---|---|---|---|---|---|---|
| | −1 | 0 | 1 | 2 | 3 | 4 |
| Remaining | — | 50 | 100 | 150 | 200 | 250 |
| Memory | | | | | | |
| Amount | | | | | | |

| | | | | |
|---|---|---|---|---|
| Type | System | Foreground | Special | Background Application |
| | Application | Application | Application | (Operated Previously) |

In the example presented as Table 1, the priority of “−1” indicates the highest priority, and the priority of “4” indicates the lowest priority. In the example presented as Table 1, the unnecessary application selecting unit 23 ends the process of the background application (an application previously operated) given the lowest priority. The remaining capacity of the RAM 3 may be still insufficient even after the process of the application or service given the priority of “4” is ended. In such a case, the unnecessary application selecting unit 23 ends the application or service given the priority of “3”.

Table 1 illustrates that the remaining memory amount is held for each priority, and the CPU 1 can end the application or service given the corresponding priority only when the remaining memory amount is below the threshold. For example, when the remaining memory amount is smaller than 250 megabytes (MB), the CPU 1 can end the application or service given priority “4”. The unnecessary application selecting unit 23 keeps selecting applications or services given the priority of “4” and ending the selected applications or services until the remaining memory amount reaches or exceeds 250 MB. Even after all the applications or services given the priority of “4” are ended, the remaining memory amount may be still smaller than 250 MB. Even in such a case, the CPU 1 does not end the applications or services given the priorities of “3”, “2”, “1”, “0”, and “−1”.

When the remaining memory amount becomes smaller than 200 MB, the applications or services given the priority of “4” and “3” are ended. The unnecessary application selecting unit 23 keeps selecting applications or services given the priorities of “4” and “3” and ending the selected applications or services until the remaining memory amount reaches or exceeds 200 MB. Even after all the applications or services given the priorities of “4” and “3” are ended, the remaining memory amount may be still smaller than 200 MB. Even in such a case, the CPU 1 does not end the applications or services given the priorities of “2”, “1”, “0”, and “−1”. That is, only when the remaining memory amount is below the amount specified in Table 1, the CPU 1 is permitted to end the application or service assigned with the priority corresponding to the specified remaining memory amount. Note that an application or a service assigned with the priority of “−1” will not be selected as a termination target even when the remaining memory amount becomes smaller.

Registration on Whitelist

The MFP according to the present embodiment has the whitelist 13 listing the applications or services the process end of which is prohibited even when the storage area of the RAM 3 is expected to be exhausted. FIG. 5 is a flowchart illustrating an operation flow for setting an authentication application in the whitelist 13.

In S21, the CPU 1 accepts an authentication method set by the user on the control panel 8. More specifically, the user sets an authentication method to be used, among a plurality of authentication methods such as USB or Bluetooth (registered trademark) authentication. In such an authentication method, as the user connects, to the MFP, a USB or Bluetooth (registered trademark) device that stores authentication information such as a USB key or a Bluetooth (registered trademark) key, use of the MFP is permitted. Alternatively, the authentication method can be a method involving manually inputting identification information (ID) or a password, a method using an ID card, a face authentication using a camera, fingerprint authentication, or the like.

In S22, the CPU 1 determines a setting application according to the authentication function and sets the authentication application to the OS 20. That is, the CPU 1 identifies an application that executes the authentication method based on the authentication method set in S21.

In S23, the CPU 1 registers, in the whitelist 13, the application set to the OS 20 at S22. The MFP can have a plurality of whitelists 13, and applications and services assigned with respective priorities may be registered for each whitelist 13. For example, the MFP can have two whitelists, one assigned with the highest priority and one assigned with the second highest priority. Further, the unnecessary application selecting unit 23 can be configured not to end the process of the applications and services registered in the highest priority whitelist. Applications and services registered in the second highest priority whitelist may be handled as application of priority equivalent to the priority of “special application” presented in Table 1. This configuration can make it difficult for the unnecessary application selecting unit 23 to end the process of the applications and services registered in the second highest priority whitelist.

Selection of Target for Process End

Next, the operation to select the process end target will be described using Table 1. In the following description, the priority of “−1” is the highest and the priority of “4” is the lowest in Table 1. However, other priority settings may be used.

The priority is assigned to each application and service, and the unnecessary application selecting unit 23 selects the application and the service to be the target of the process end, according to the priority. Applications and services are made targets of process end in ascending order of priority, and applications and services assigned with high priorities are less likely to be ended. The process end of the application and the service assigned with the priority of “−1”, which is the highest priority, are prohibited. That is, even when the remaining amount of the RAM 3 is exhausted, the process of the application or service assigned with the priority “−1” is not to be ended. On the other hand, when the remaining amount of the RAM 3 is exhausted, the process of the applications or services assigned with the priorities of “0” to “4” is ended in accordance with the priority.

Priority of “−1” is assigned to the applications and services required for the OS 20 or the system of the MFP such as the system application. A higher priority is assigned to a foreground application or special application, to reduce the possibility of process end. The priority assigned to a background application is changed according to the process information (activation order, memory usage amount, or the like). That is, when a background application is selected by the user or newly activated, the background application becomes a foreground application. In this case, the priority for the foreground application is assigned thereto. Also, when another application is activated after a background application becomes a foreground application, the foreground application returns to the background application, and the priority for the background application is again assigned thereto.

Applications and services necessary for the system of the MFP can be assigned with the priority of “−1”, to prevent the termination of the process thereof. Alternatively, applications and services necessary for the system of the MFP can be assigned with the priority of “1”, to reduce the possibility of process end thereof. Such priorities are determined and assigned based on the characteristics of the application or the service. For example, the priority of “−1” is assigned to such applications and services that the system is not established if a process such as connecting to another device or authentication function is ended, thereby prohibiting the process end. In addition, to applications and services that will impose an inconvenience on the user when the process thereof is ended, such as an application involving real-time operation, the priority of “1” is assigned, to reduce the possibility of process end.

Operation at System Startup

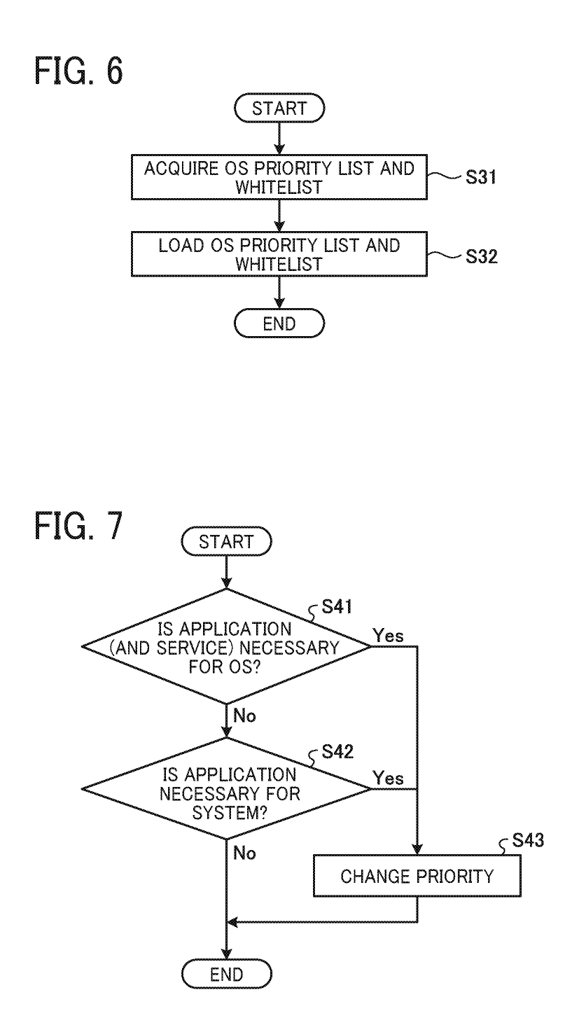

Next, descriptions are given below of the operation at the system startup including activation of the OS of the MFP, with reference to the flowchart of FIG. 6. At the time of activation, the CPU 1 acquires the OS necessity list 14 and the whitelist 13 from the HDD 4 (S31). The OS necessity list 14 is a list in which applications and services necessary for the OS 20 are registered as illustrated in Table 2 below.

TABLE 2
Name

Application A
Application B
Service A

In the example presented as Table 2, applications A and B and a service A are registered as being necessary for the OS 20 in the OS necessity list 14. The process end of the applications and services registered in the OS necessity list 14 is prohibited (the process is not to be ended). That is, the OS necessity list 14 is a list of applications or services assigned with the priority of “−1” in the priority list 12.

An example of the whitelist 13 is illustrated in Table 3 below.

TABLE 3

| Priority | Name |
|---|---|
| First Whitelist | Application C |
| | Application D |
| | Service B |
| Second Whitelist | Application E |
| | Service C |

In the example of Table 3, the priority of the first whitelist is higher than the priority of the second whitelist. Applications C and D and a service B are registered in the first whitelist. Application E and C are registered in the second whitelist. The applications C and D and the service B registered in the first whitelist are applications or service whose processes are not to be ended, that is, applications or services assigned with the priority of “−1” in the priority list 12. The application or service registered in the second whitelist is an application or a service whose process is less likely to be ended, that is, an application or service assigned with the priority of “1” in the priority list 12. Thus, a plurality of whitelists 13 may be provided for different priorities, respectively.

Next, the CPU 1 loads the OS necessity list 14 and the whitelist 13 into the RAM 3 and creates the priority list 12 (S32). The operation of creating the priority list 12 will be described later with reference to the flowchart of FIG. 7.

The priority list 12 is a list specifying the priority for each application and each service, for example, as illustrated in Table 4 below. Alternatively, as illustrated in Table 1, the priority list 12 can be a list in which applications and services are registered per priority.

TABLE 4

| Name | Priority |
|---|---|
| Application A | −1 |
| Application B | −1 |
| Service A | −1 |
| Application C | −1 |
| Application D | −1 |
| Service B | −1 |
| Application E | 1 |
| Service C | 1 |
| . | . |
| . | . |
| . | . |

The priority list 12 can be stored to be referred to by the CPU 1 and the OS 20. For example, the priority list 12 is loaded into the RAM 3. In one example, the CPU 1 sets the priority of an application or a service registered in the OS necessity list 14 to “−1” and sets the priority of an application or a service registered in the whitelist 13 to “−1” (or “1”). The created priority list 12 can be stored in the HDD 4 to be retrieved from in the HDD 4 next time the system is activated. Alternatively, the priority list 12 can be created each time the system is activated.

Note that the CPU 1 updates the priority list 12 after the system is activated. In other words, when an application or service is activated by the user operation or the like after the system activation, or when an application or service is automatically activated by the system, the priority list 12 is updated to add that application and the priority thereto. Further, when the application shifts to the foreground or the background due to a user operation or the like, the priority list 12 is updated to change the priority of that application.

Creation of Priority List Next, an operation to create the priority list 12 will be described with reference to the flowchart of FIG. 7. Based on the OS necessity list 14 acquired in S31 in the flowchart of FIG. 6, the CPU 1 determines whether the application or service is necessary for the OS 20 (S41). In response to a determination that the application or service is necessary for the OS 20 (Yes in S41), the CPU 1 changes the priority thereof (S43).

Further, based on the whitelist 13 acquired in S31 in the flowchart of FIG. 6, the CPU 1 determines whether the application or service is necessary for the system (S42). In response to a determination that the application or service is necessary for the system (Yes in S42), the CPU 1 changes the priority thereof (S43). As a result, the whitelist 13 keeps the applications and services unnecessary for the OS 20 but necessary for the system.

The CPU 1 does not change the priority of an application or service that is not registered in the OS necessity list 14 or the whitelist 13. In this case, the CPU 1 sets the priority of the application or service depending on whether the environment in which the application or service operates is foreground or background.

As described above, since the MFP according to the present embodiment registers the application and the service necessary for the OS 20 and the system to the list, the MFP according to the present embodiment can prevent the inconvenience that the process of the application or service necessary for the OS 20 or the system is terminated. If the process of an application or service necessary for the OS 20 or the system of the MFP is terminated when the remaining amount of the RAM 3 (memory) becomes small, a trouble may occur in the system. According to the present embodiment, while such a trouble can be prevented, the capacity of the RAM 3 (memory) can be secured.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising:
an internal memory configured to store information on at least one process-end prohibition item being one of an application program and a service whose process end is prohibited in at least one of an operation system of the information processing apparatus and a system employing the information processing apparatus; and
circuitry configured to:
detect a remaining capacity of a memory in response to a use request for the memory;
detect an occupying application program and an occupying service occupying the memory;
refer to the information on the at least one process-end prohibition item stored in the internal memory, in response to a detection result that the remaining capacity of the memory becomes equal to or smaller than a threshold by use of the memory in accordance with the use request;
select, from the occupying application program and the occupying service occupying the memory, an unprohibited item that is not contained in the information on the at least one process-end prohibition item; and
end a process of the selected unprohibited item to reserve, on the memory, a capacity requested by the use request.

2. The information processing apparatus according to claim 1,
wherein the circuitry is configured to add, to the information on the at least one process-end prohibition item, information on any application program and any service.

3. The information processing apparatus according to claim 1,
wherein a priority is given to each of the at least one process-end prohibition item, and
wherein the circuitry is configured to end the the occupying application program and the occupying service in descending order of the priority, to reserve, on the memory, the capacity requested by the use request.

4. An information processing method comprising:
detecting a remaining capacity of a memory in response to a use request for the memory;
detecting an occupying application program and an occupying service occupying the memory;
referring to information on at least one process-end prohibition item in response to a detection result that the remaining capacity of the memory becomes equal to or smaller than a threshold by use of the memory in accordance with the use request, the at least one process-end prohibition item being one of an application program and a service whose process end is prohibited in at least one of an operation system of an information processing apparatus and a system employing the information processing apparatus;
selecting, from the occupying application program and the occupying service occupying the memory, an unprohibited item that is not contained in the information on the at least one process-end prohibition item; and
ending a process of the selected unprohibited item to reserve, on the memory, a capacity requested by the use request.

5. A non-transitory recording medium storing a plurality of program codes which, when executed by one or more processors, cause the processors to perform a method, the method comprising:
detecting a remaining capacity of a memory in response to a use request for the memory;
detecting an occupying application program and an occupying service occupying the memory;
referring to information on at least one process-end prohibition item in response to a detection result that the remaining capacity of the memory becomes equal to or smaller than a threshold by use of the memory in accordance with the use request, the at least one process-end prohibition item being one of an application program and a service whose process end is prohibited in at least one of an operation system of an information processing apparatus and a system employing the information processing apparatus;
selecting, from the occupying application program and the occupying service occupying the memory, an unprohibited item that is not contained in the information on the at least one process-end prohibition item; and
ending a process of the selected unprohibited item to reserve, on the memory, a capacity requested by the use request.
